(19) United States
(12) Patent Application Publication
(10) Pub. No.: US 2013/0297502 A1
(43) Pub. Date: Nov. 7, 2013

(54) Mobile Transaction network using a prepaid VTN card

(71) Applicant: PETER IYIOLA OJO, Laurel, MD (US)

(72) Inventor: PETER IYIOLA OJO, Laurel, MD (US)

(21) Appl. No.: 13/465,363

(22) Filed: May 7, 2012

(51) Int. Cl. G06Q 20/34

(52) U.S. Cl. CPC G06Q 20/342
USPC 705/41

(57) ABSTRACT

A method of storing money on VTN prepaid card purchased at agent location and transferring the money using a hybrid VTN mobile and internet procedure to the recipient.

This method eliminates charge backs because the method is a close loop network that is not subject to credit card Company's chargeback threat.

### TECHNICAL FIELD

The present disclosure relates to funding movement using a hybrid VTN prepaid card leveraging on mobile technology and the internet

### BACKGROUND

Currently the unbanked and majority of the target users have very limited access to a payment system like credit card. Even when they get a credit card, online merchant are not willing to take the risk by accepting the credit cards. This invention solves this problem because it allows users to pay a local or merchants in another country in local currency without fear of rejection. The current system is too expensive for low income earners, and even when they are able to get a debit/credit card, most online merchants do not accept the cards due to the chargeback possibilities and the perceived notion that there is too much fraud associated with the current solution. This invention is cash based and protect merchants. This invention is inexpensive and merchants using the invention are willing to accept the method of payment without fear of chargeback.

### SUMMARY OF THE DISCLOSURE

A special method for transferring money using mobile phone or on the internet acceptable to global merchants. This invention allows the unbanked to have access to a payment system in local currency. This invention also allows VTN prepaid card to be used to load money on the account. This invention also allows users to use the funds on their account to trade for stocks online. The card is a store value card that can be used to transfer money on VTN network to anybody with a VTN account. The recipient can be resident in any country or in the local market.

The method of obtaining the card is unique because it has to be made active through a number of channels. The channels are Super agent of VTN, Master Agent of VTN. If the card is not active at the super agent level, Master agent will not be able to activate or end users. If the card is not activated by Master Agents, end users will not be able to use it. This invention allows for optimum security of the card such that even if the source card numbers are revealed, the fund on the card is still protected.

The mobile payment platform also allows users to send money out to Western Union network instantly. This invention allows funds to be transferred on VTN network, to western union without going through the bank or western union agent outlet.

This invention allows users to load money onto their Virtual and Plastic MasterCard directly using the VTN prepaid card method directly. In the process, VTN network convert the funds on the VTN prepaid card into an electronic form, debit the customer on VTN platform, channel the fund to card promoter in a special process that requires no local bank intervention. The settlement is done between VTN and card issuer and the accepting bank in USA

In this invention, a recipient of money need not have an account. The logic built into the invention creates a temporary account for the recipient of money. The sender of money must have an account that is funded.

In order for user to send money from their account to another account, user must first sign into account online or via mobile phone, then user must click on the send money button. Once the send money is clicked or selected, the following requirements that the user must have for Web module are: Recipient Email ID: (Required) and 2. Amount to be sent: (Required)

Requirements that user must have for GSM Phone mobile transaction are 1. Recipient Email ID: (Required). 2. Amount to be sent: (Required). 3. Sender Email ID: (Required). 4. Sender PIN: (Required)

If recipient is not found, the system is designed to automatically create a new temporary account for the recipient. The system checks account balance. After the above step, the system checks to make sure there are enough funds in the senders account. If insufficient funds, the system will return Error Message. If there is enough money to cover the transaction, the system debits the amount from sender account and the system credit the amount to recipient's account. The commission due is then paid to settlement Account, and the settlement account shares among all parties involved such as the platform provider, VTN, Bank and agent.

Funding VTN via scratch card (plastic and electronic): Customer purchase physical cards from Banks/Master Agent resellers. To load the card, the customer must authenticate the scratch card number. If a duplicate card number is detected, the transaction will be aborted, otherwise, the value on card is released into the VTN account of customer. Thereafter, X % of card loading fee credited to VTN and X % of card loading fee credited to Reseller Agent.

The invention works on any computer that is connected to the internet. The invention works on any mobile phone with SMS capability. The invention can be used for stock trading. The invention can be used for gas loyalty e-payment. The invention can be used to send or receive donations. The invention can be used for recurring billing in bill payment. The invention can be used for revenue collection.

Currently the unbanked and majority of the target users have very limited access to a payment system like credit card. Even when they get a credit card, online merchant are not willing to take the risk by accepting the credit cards. This invention solves this problem because it allows users to pay a local or merchants in another country in local currency without fear of rejection.

The current system is too expensive for low income earners, and even when they are able to get a debit/credit card, most online merchants do not accept the cards due to the chargeback possibilities and the perceived notion that there is too much fraud associated with the current solution. This invention is cash based and protect merchants. This invention is inexpensive and merchants using the invention are willing to accept the method of payment without fear of chargeback.

A special method for transferring money from Nigeria using mobile phone or on the internet acceptable to global merchants. This invention allows 80% of the unbanked in Nigeria to have access to a payment system in local currency. This invention also allows a special type of prepaid card to be used to load money on the account. This invention also allows users to use the funds on their account to trade for stocks online.

A special method for transferring money from Nigeria using VTN prepaid card. The card is a store value card that can be used to transfer money on VTN network to anybody with a VTN account. The recipient can be resident in Nigeria or living outside Nigeria.

The method of obtaining the card is unique because it has to be made active through a number of channels. The channels are Super agent of VTN, Master Agent of VTN. If the card is not active at the super agent level, Master agent will not be able to activate or end users. If the card is not activated by Master Agents, end users will not be able to use it. This invention allows for optimum security of the card such that even if the source card numbers are revealed, the fund on the card is still protected.

The platform allows Nigerians to send money out to Western Union network instantly for the first time in history of Nigeria. This invention allows funds to be transferred on VTN network, to western union without going through the bank or western union

This invention allows users to load money onto their Virtual and Plastic MasterCard directly using the VTN prepaid card method directly. In the process, VTN network convert the funds on the VTN prepaid card into an electronic form, debit the customer on VTN platform, channel the fund to card promoter in a special process that requires no local bank intervention. The settlement is done between VTN and card issuer and the accepting bank in USA

### BRIEF DESCRIPTION OF THE DRAWINGS

FIG. 1. Illustrates how customer can withdraw funds from the VTN platform for pick up at agent location. Agent could be ordinary businesses or participating banks

FIG. 1 0101 Illustrates how customer login to the VTN system

FIG. 1.0102 Illustrates how customer choose to withdraw via Web Module

FIG. 1.0103 Illustrates how customer choose to withdraw via Mobile device

FIG. 1.0104 Illustrates how customer enter the amount to be withdraw and mode of withdraw Cash/to send to Bank account

FIG. 1.0105 Illustrates how customer enters the amount to be withdrawn and enters the required information such as Sender Email ID and Sender PIN

FIG. 1.0106 Illustrates how the system check the account balance

FIG. 1.0107 Illustrates how the system automatically generate a withdraw VTCN number for the customer

FIG. 1.0108 Illustrates how the system generate error in case of insufficient funds

FIG. 2. Illustrates how to withdraw fund from VTN to Bank accounts

FIG. 2.0202 Illustrates how customer log on to the system

FIG. 2.0203 Illustrates how customer select the mode of withdraw

FIG. 2.0204 Illustrates how customers select to withdraw at agent bank

FIG. 2.0205 Illustrates how customers select to withdraw to their bank account

FIG. 2.0206 Illustrates how commission is paid to settlement account under withdraw from agents and bank agent's option

FIG. 2.0207 Illustrates how commission is paid to settlement account under withdraw to Bank account option

FIG. 2.0208 Illustrates how Commission is paid to VTN account

FIG. 2.0209 Illustrates how commission is paid to settlement account

FIG. 2.0210 Illustrates how Commission is paid to partner Banks

FIG. 2.0211 Illustrates how Commission is paid to other Bank/Agent account

FIG. 3. Illustrates the sending payment module

FIG. 3.0301 Illustrates how the logon on to the system

FIG. 3.0302 Illustrates how the customer initiates the send payment online

FIG. 3.0303 Illustrates how the customer initiates the send payment via Mobile device

FIG. 3.0304 Illustrates the requirements that the user must have for Web module: Recipient Email ID, Amount to be sent

FIG. 3.0305 Illustrates the requirements that user must have for GSM Phone mobile: Recipient Email ID, Amount to be sent, Sender Email ID, and Sender PIN

FIG. 3.0312 Illustrates that if recipient is not found, the system should create new VTN Account for the Recipient

FIG. 3.0306 Illustrates how the system check account balance

FIG. 3.0307 Illustrates that If insufficient are found, the system will return Error Message

FIG. 3.0309 Illustrates that if there is enough fund to cover the transaction, the system should debit the amount from sender account

FIG. 3.0310 Illustrates how the system credit the amount to recipient's account

FIG. 3.0311 Illustrates how the commission is paid to Settlement Account

FIG. 3.0314 Illustrates how commission of 25% paid to partner Bank account on VTN network

FIG. 4 Illustrates Funding process via scratch card (plastic and electronic)

FIG. 4.0401 Illustrates how customers purchase physical cards from Banks/resellers

FIG. 4.0402 Illustrates how customers purchase electronic scratch cards from Resellers

FIG. 4.0403 Illustrates VTN Scratch Card Loading Module

FIG. 4.0404 Illustrates how VTN Scratch Card Number authenticated

FIG. 4.0406 Illustrates Duplicate Record

FIG. 4.0407 Illustrates how value on card is release to VTN account of customer

FIG. 4.0408 Illustrates how X % of card loading fee is credited to VTN

FIG. 4.0409 Illustrates how X % of card loading fee credited to Reseller Agent

FIG. 5 illustrates how to use VTN mobile payment platform for electronic retail stock trading

FIG. 5.0501 illustrates how stock trader registered on trading platform

FIG. 5.0502 Illustrates how stock trader registers and select among a list of broker of choice to execute buy or sell instructions

FIG. 5.0503 Illustrates how stock trader agree to terms

FIG. 5.0504 Illustrates how stock broker review company stocks, prices and click on buy. Payment executed via VTN platform. Broker receives payment confirmation on their interface along with stock trader's instructions

FIG. 5.0505 Illustrates how stock data feed from NSE to trading platform in real time

FIG. 5.0506 Illustrates how VTN debit Traders account credit brokers account

FIG. 5.0507 Illustrates how the agreed transaction fees is split and deposited into the respective VTN account of all parties

FIG. 5.0508 Illustrates how stock broker executes buy instructions

FIG. 5.0509 Illustrates how Trader receives confirmation

FIG. 5.0510 Illustrates how Stock broker updates platform

FIG. 5.05011 Illustrates how a trader is notified

FIG. 5.0512 Illustrates how the commission is paid to settlement account of VTN

FIG. 5.0513 Illustrates how the commission is paid to VTN Account

FIG. 5.0514 Illustrates how the commission is paid to partner bank account on VTN Network

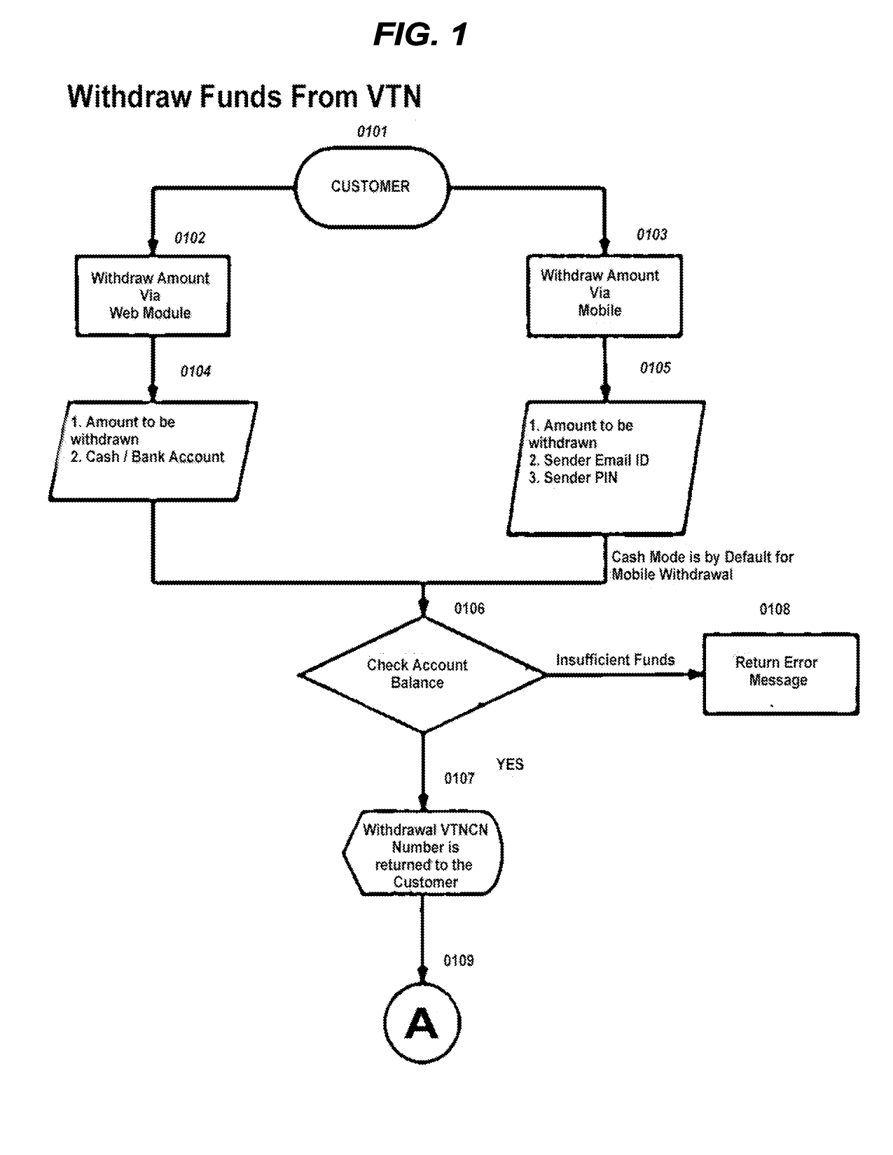

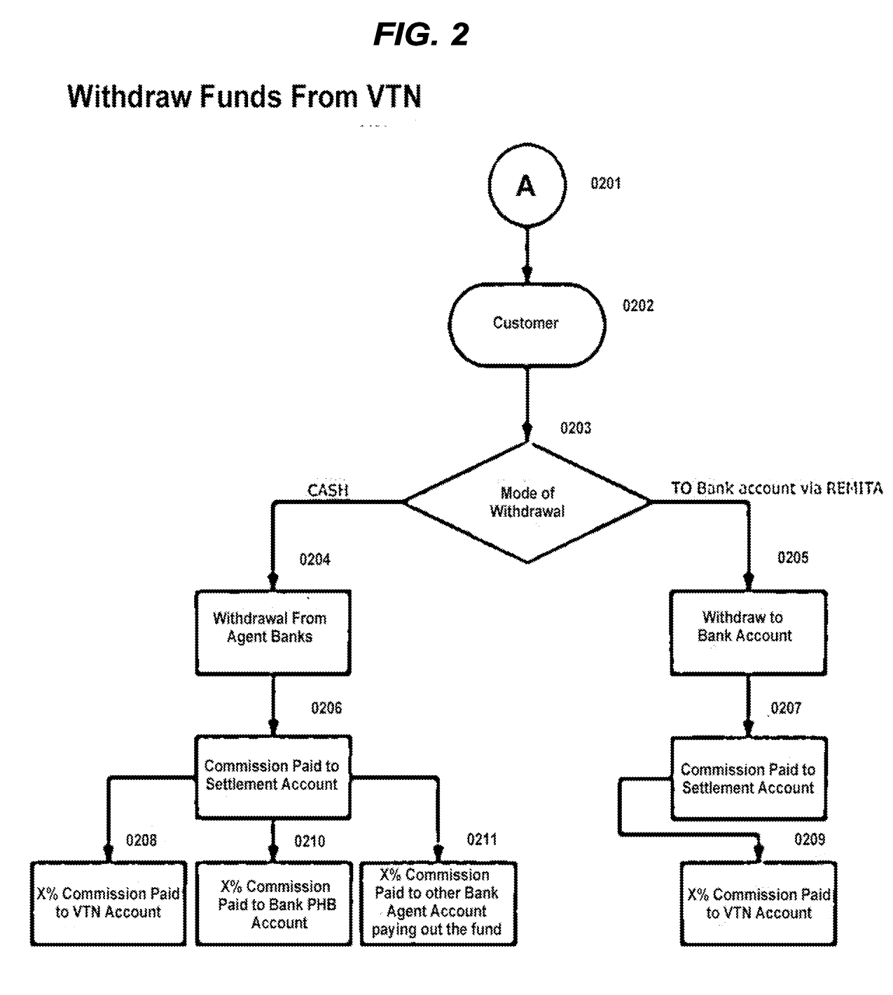

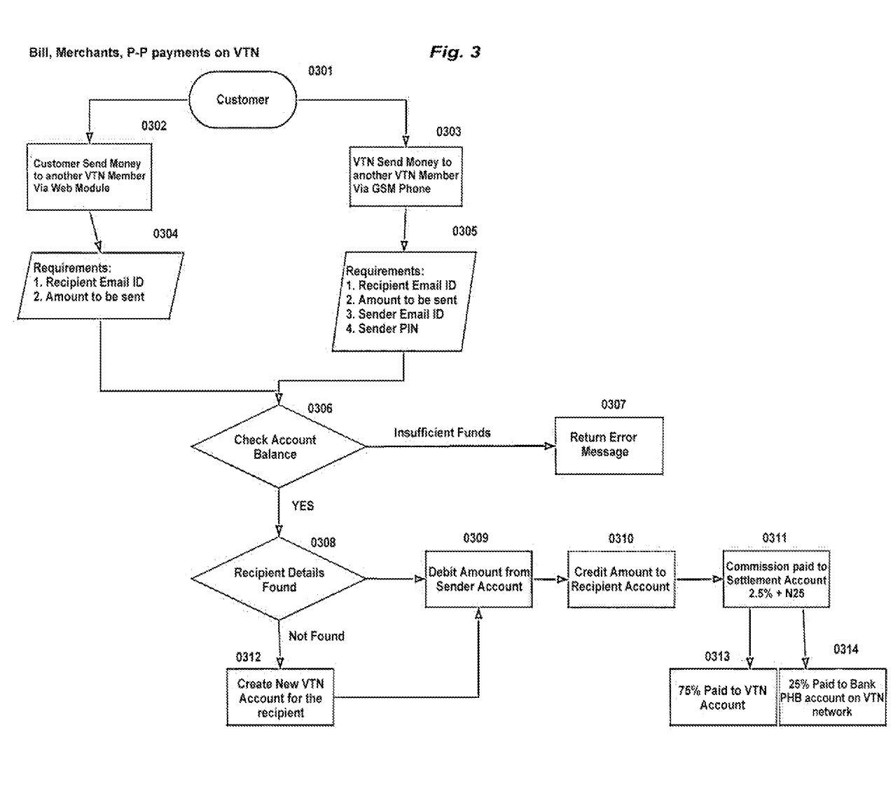

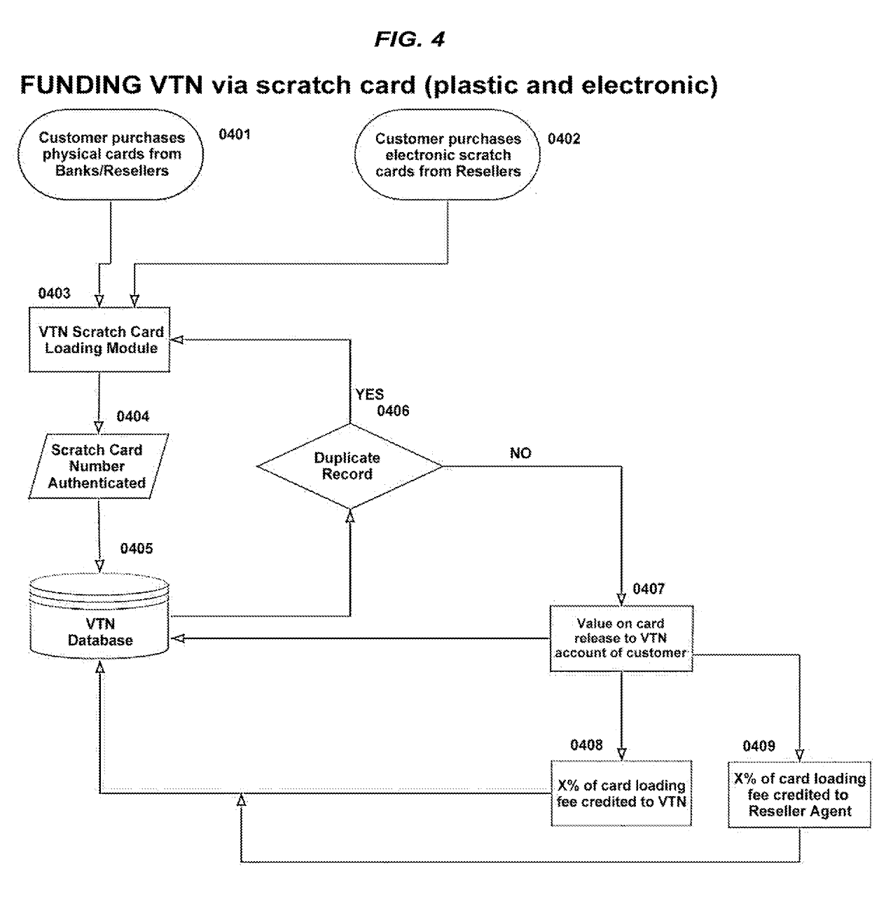

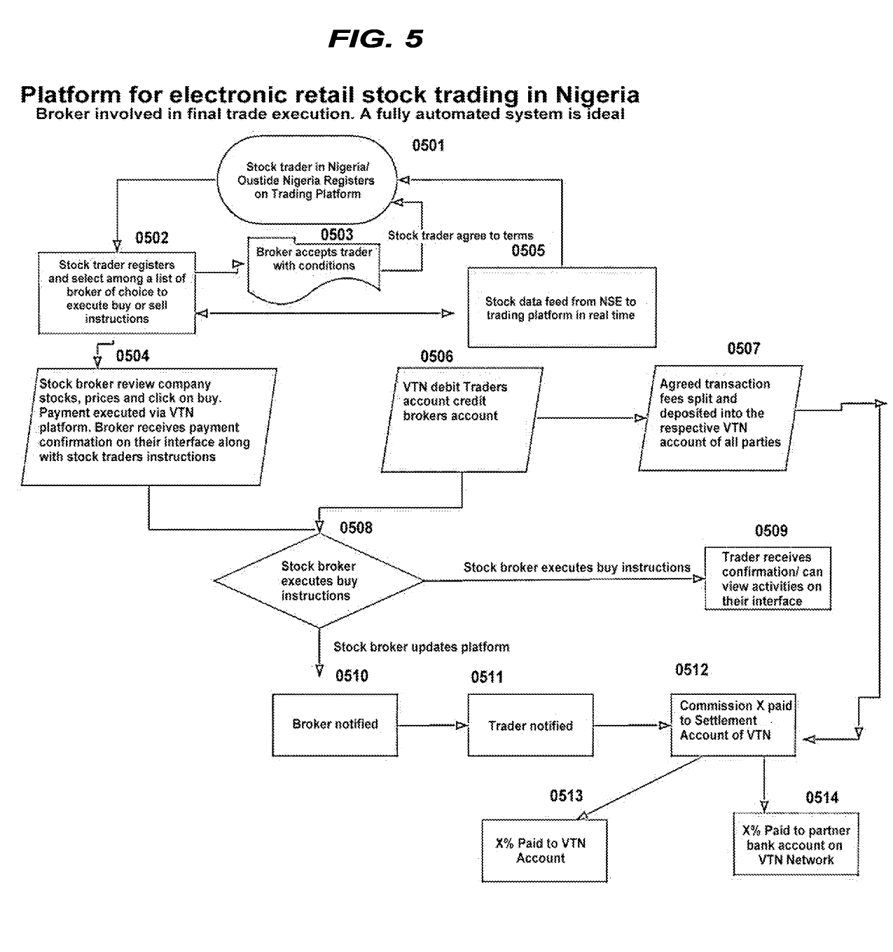

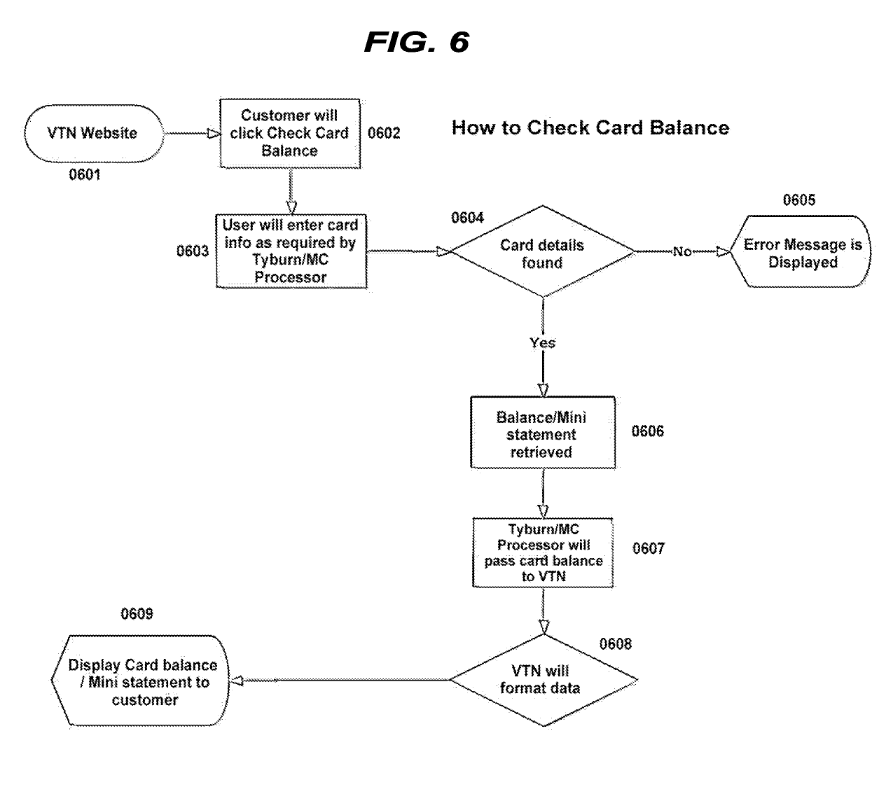

The claims herein are not limited to the exact configuration and methodologies illustrated above. There could be various changes and modifications that can be made to the above without departing from the scope of the claims

1. A method of transferring money stored on VTN prepaid card using any mobile device with internet browsing or capability to run VTN mobile java application.

2. The method of claim 1, wherein the money loaded on the card is converted to electronic form

3. The method of claim 1, wherein the balance on the card is debited and the value is registered on the database.

4. The Method of claim 2, wherein the account number of user, phone number and other identifying information such as email is entered into the database and stored along with the balance on card

5. The method of claim 4, wherein the balance stored is stored as credit in the database

6. The method of claim 5, wherein transfer request by customer is transmitted via SMS protocol or internet protocol or USSD protocol to the server along with customer identifying information such as mobile phone number, email, first name, last name, mobile number of recipient, name of recipient

7. The method of claim 6, wherein the server validate the information transmitted to the server and compare the amount to be transferred with the balance on the account of the sender

8. The method of claim 7, wherein if the amount to be transferred is greater that the balance on the account, the transaction is permitted and the amount is debited, thereby reducing the customer balance

9. The method of claim 8, wherein the amount debited is credited to the account of the sender in real-time

10. The method of claim 9, wherein the sender is notified via sms and email along with the confirmation number preceding with a number comprising of numbers and alphabets

11. The method of claim 9, wherein the recipient is notified via sms and email along with confirmation numbers comprising of numbers and alphabets and a number preceding with VTNC

12. The method of claim 11, wherein the VTCN numbers can be used to cash out the transfer at agent location

13. The method of claim 12, wherein the agent will enter the VTCN number to validate the transfer and pay out fund to recipient

14. A method of paying for stock trading using the VTN payment method

15. The method of claim 14, wherein stock traders can accept VTN payment method to execute buy, and sell stock trading

16. The method of claim 15, wherein the stock trader will register as a merchant on VTN platform

17. The method of claim 16 wherein the stock trader identifying information such as business name, first name, last name, mobile number are stored in database in order to credit their account whenever fund is credited to their account

18. The method of claim 17, wherein fund received are credited to the merchant account of stock trader and the fee debited in real-time

19. A method of sending money out to Western Union network and receive money from Western Union network

20. The method of claim 19, wherein user can click a menu to send money to Western Union network to anybody world wide

21. The method of claim 19, wherein user can receive Western Union money transfers into their VTN mobile wallet in real-time

22. The method of claim 21, wherein the western union transfers received is credited to the account of the recipient and the database is updated to reflect the same

23. A method of activating VTN prepaid card for Master Agents by Super Agent and method of activating VTN prepaid card by Master Agents for Customers

24. The method of claim 23, wherein the VTN prepaid card is activated for Master agents before they can sell to customers

25. The method of claim 24, where during the activation, the card serial numbers and card control numbers are uploaded into the activation interface on VTN payment network

26. The method of claim 25, wherein the cards requested by Master Agents are assigned only to the Master agent. Once assigned the cards cannot be sold by any other Master agent

27. The method of claim 26, wherein the MasterAgent can sell and assign the card to end user customers using the activation menu

28. The method of claim 27, wherein the activated card can how be used to load money on the VTN account of the customer via their mobile phone or online

29. A method of loading, money on VTN platform to MasterCard or Visa Card which allows user to use the MasterCard or Visa Card to pay for goods and services online

30. The method of claim 27, wherein users can load money on a MasterCard and use it to pay at agent online stores here VTN prepaid card method is not accepted

31. The method of claim 28, wherein, VTN account of customer is debited and the MasterCard is credited with the US dollar equivalent

32. The method of claim 29, wherein the MasterCard card information such as card number, expiration date, 3 digit security numbers are automatically made available to customer in a secure PDF format.
